(19) United States
(12) Patent Application Publication
(10) Pub. No.: US 2013/0114781 A1
(43) Pub. Date: May 9, 2013

(54) FULLY CERAMIC MICROENCAPSULATED REPLACEMENT FUEL ASSEMBLIES FOR LIGHT WATER REACTORS

(71) Applicants: Francesco Venneri, Los Alamos, NM (US); Won Jae Lee, Taejon (KR)

(72) Inventors: Francesco Venneri, Los Alamos, NM (US); Won Jae Lee, Taejon (KR)

(21) Appl. No.: 13/669,200

(22) Filed: Nov. 5, 2012

Related U.S. Application Data
(60) Provisional application No. 61/556,191, filed on Nov. 5, 2011.

(51) Int. Cl. G21C 3/07

(52) U.S. Cl. 376/419; 376/434; 376/412

(57) ABSTRACT

A fully ceramic micro-encapsulated fuel assembly for a light water nuclear reactor includes a set of FCM fuel rods bundled in a square matrix arrangement. Fully ceramic micro-encapsulated fuel assemblies replace standard reference solid fuel assemblies with smaller number of FCM fuel rods that have a larger diameter than the diameter of the solid standard reference fuel rods, while keeping similar amounts of fissile material in the fuel assembly and maintaining comparable rates of burnup and number of EFPDs, and compatible power production, heat transfer and thermo-hydraulic features. A fully ceramic micro-encapsulated fuel rod includes multiple fully ceramic micro-encapsulated fuel pellets, which are comprised of tristructural-isotropic particles. In order to obtain compatible burnup rates with the standard reference fuel, the tristructural-isotropic particles have preferentially large diameter and packing fraction. Furthermore, Erbium oxide is included in the sintered mix of the SiC compact to serve as a burnable poison.

### CROSS REFERENCE TO RELATED APPLICATIONS

This application claims the benefit and priority of U.S. Patent Application No. 61/556,191, entitled “FULLY CERAMIC MICROENCAPSULATED (FCM) REPLACEMENT FUEL ASSEMBLIES FOR LWRS,” filed Nov. 5, 2011, which is hereby incorporated by reference in its entirety. Furthermore, this application is related to a U.S. patent application Ser. No. 13/567,243, entitled “DISPERSION CERAMIC MICRO-ENCAPSULATED (DCM) NUCLEAR FUEL AND RELATED METHODS,” filed Aug. 6, 2012, which is hereby incorporated by reference.

### FIELD OF THE DISCLOSURE

The present invention relates generally to nuclear technologies, and more particularly relates to a fuel assembly and tristructural-isotropic fuel particles for increasing the safety of fuel in accident conditions while retaining operational compatibility relative to standard reference reactor fuel.

### DESCRIPTION OF BACKGROUND

Nuclear fuel undergoes fission to produce energy in a nuclear reactor, and is a very high-density energy source. Oxide fuels such as uranium dioxide are commonly used in today's reactors because they are relatively simple and inexpensive to manufacture, can achieve high effective uranium densities, have a high melting point, and are inert to air. They also provide well-established pathways to reprocessing. For example, solid uranium dioxide (“UO₂”) is widely used in light water reactors (“LWRs”). To be used as LWR fuel, uranium dioxide powder is compacted into cylindrical pellets and sintered at high temperatures to produce ceramic nuclear fuel pellets with a high density. Such fuel pellets are then stacked into metallic tubes (“cladding”). Cladding prevents radioactive fission fragments from escaping from the fuel into the coolant and contaminating it. The metal used for the tubes depends on the design of the reactor. Stainless steel was used in the past, but most reactors now use a zirconium alloy which, in addition to being highly corrosion-resistant, has low neutron absorption. The use of zirconium instead of stainless steel allows lower enrichment fuel to be used for similar operating cycles.

The sealed tubes containing the fuel pellets are termed fuel rods, which are grouped into fuel assemblies used to build up the core of a nuclear power reactor. Each fuel assembly includes fuel rods bundled in an arrangement of 14×14 to 17×17 depending on the reactor core design. A reactor core includes multiple fuel assemblies, such as 400 or 800 fuel assemblies.

Micro-encapsulated tristructural-isotropic (“TRISO”) fuel particles compacted within a graphite matrix have been developed for a new generation of gas-cooled reactors. A TRISO fuel particle comprises a kernel of fissile/fertile material coated with several isotropic layers of pyrolytic carbon (“PyC”) and silicon carbide (“SiC”). These TRISO particles are combined with a graphite matrix material and pressed into a specific shape. The TRISO fuel forms offer much better fission product retention at higher temperatures and burnup than metallic or solid oxide fuel forms, such as the solid oxide fuel used in present day Light Water Reactors (LWRs). Burnup is a measure of how much energy is extracted from a nuclear fuel source. It is measured as the fraction of fuel atom that underwent fission in fissions per initial metal atom (“FIMA”). Burnup is also measured as the actual energy released per mass of initial fuel in, for example, megawatt-days/kilogram of heavy metal (“MWd/kgHM”). Higher burnup may not only reduce the overall waste volume but also limit possible nuclear proliferation and diversion opportunities. While high burnup is desirable, it is also important that burnup rates for the replacement TRISO based fuel should be not too fast and should at least match the burnup rate of the reference standard fuel, in order to achieve comparable service in the reactor

Recently, fully ceramic micro-encapsulated (“FCM”) fuel has been proposed for light water reactors (“LWRs”). FCM fuel utilizes TRISO fuel particles, which are pressed into compacts using SiC matrix material and loaded into fuel pins. However, the heavy metal mass in a FCM fuel pellet tends to be considerably lower than that of a conventional solid fuel pellet due to the limited space available for heavy metal and fissile mass inside TRISO particles of FCM fuel. Accordingly, there exists a need to increase the heavy metal and fissile mass in a FCM fuel pellet and in the fuel assembly formed by the union of FCM fuel pellets by increasing the enrichment of the fuel, the fuel volume inside the TRISO particles, the particle packing fraction in the pellets, and the diameter of the pellets in the fuel assembly within specific limits advised by physics, engineering and regulatory considerations.

### OBJECTS OF THE DISCLOSED SYSTEM, METHOD, AND APPARATUS

An object of the fully ceramic micro-encapsulated fuel assembly is to provide greater safety during operations and in accident situations, relative to standard reference fuel assemblies;

An object of the fully ceramic micro-encapsulated fuel assembly is to provide compatibility with the standard reference fuel assembly used in current LWRs, by matching the fissile loading of the standard reference LWR fuel assembly in order to achieve similar operational behavior in the reactor core, and by matching neutronics thermo-hydraulics operational parameters, such as reactivity coefficients, heat generation, heat transfer and pressure drop.

An object of the fully ceramic micro-encapsulated fuel assembly is to provide 12×12 FCM fuel assemblies to replace 16×16 solid fuel assemblies in light water reactors;

An object of the fully ceramic micro-encapsulated fuel assembly is to provide 13×13 FCM fuel assemblies to replace 17×17 solid fuel assemblies in light water reactors;

An object of the tristructural-isotropic (TRISO) particles is to provide TRISO particle kernels with increased kernel diameter;

An object of the TRISO particles is to increase the heavy metal mass in the fully ceramic micro-encapsulated fuel pellets;

An object of the fully ceramic micro-encapsulated fuel pellet is to lower initial reactivity using a burnable poison;

An object of the fully ceramic micro-encapsulated fuel pellet and TRISO particles is to slow down and extend the burnup for the fully ceramic micro-encapsulated fuel;

Other advantages of the disclosed fully ceramic micro-encapsulated fuel assembly and TRISO particles will be clear to a person of ordinary skill in the art. It should be understood, however, that a system, method, or apparatus could practice the disclosed fully ceramic micro-encapsulated fuel assembly and TRISO particles while not achieving all of the enumerated advantages, and that the fully ceramic micro-encapsulated fuel assembly and TRISO particles are defined by the claims.

### SUMMARY OF THE DISCLOSURE

By utilizing a replacement fuel assembly of fully ceramic micro-encapsulated (FCM) fuel rods that are smaller in number and larger in diameter than conventional solid UO₂ fuel rods in a standard reference fuel assembly, the heavy metal and fissile mass in the FCM fuel pellets is increased, while retaining operational compatibility with the standard reference fuel assembly. For light water reactors, 12×12 FCM fuel assemblies are provided to replace 16×16 solid fuel assemblies and 13×13 FCM fuel assemblies are provided to replace 17×17 solid fuel assemblies. The transformation is obtained while retaining heat transfer and pressure drop compatibility for the replacement FCM fuel assembly.

The heavy metal and fissile mass in the FCM fuel pellet is also increased by increasing the diameter of the kernel of each tristructural-isotropic (TRISO) particle in the FCM fuel pellet, and/or the packing fraction of the TRISO particles in the compact and/or the fissile enrichment of the heavy metal. In one embodiment, the kernel diameter is increased from four hundred micrometers up to eight hundred micrometers. In another embodiment, the enrichment is increased from five percent (5%) up to twenty percent (20%). In yet another embodiment the packing fraction is increased from thirty percent (30%) to forty percent (40%) or fifty percent (50%) or more, up to the allowed limits of the compacting process.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. Although the characteristic features of this invention will be particularly pointed out in the claims, the invention itself, and the manner in which it may be made and used, may be better understood by referring to the following description taken in connection with the accompanying drawings forming a part hereof, wherein like reference numerals refer to like parts throughout the several views and in which:

FIG. 1 is a cross-sectional view of a 12×12 FCM replacement fuel assembly for a reference standard 16×16 solid fuel assembly used in current reactors in accordance with this disclosure;

FIG. 2A is a partial cross-sectional view of a 12×12 FCM replacement fuel assembly for a reference standard 16×16 solid fuel assembly in accordance with this disclosure;

FIG. 2B is a partial cross-sectional view of a reference standard 16×16 UO₂ fuel assembly in accordance with this disclosure;

FIG. 3 is a graph illustrating the correlation between the k-infinity multiplication factor and burnup for various FCM fuel arrangements in accordance with this disclosure;

FIG. 4A is a graph illustrating the correlation between the k-infinity multiplication factor and burnup for various FCM fuel arrangements in accordance with this disclosure;

FIG. 4B is a graph illustrating the correlation between the k-infinity multiplication factor and burnup for various FCM fuel arrangements in accordance with this disclosure;

FIG. 4C is a graph illustrating the correlation between the k-infinity multiplication factor and burnup for various FCM fuel arrangements in accordance with this disclosure;

FIG. 4D is a graph illustrating the correlation between the k-infinity multiplication factor and burnup for various FCM fuel arrangements in accordance with this disclosure;

FIG. 5 is a graph illustrating the correlation between the k-infinity multiplication factor and effective full-power days for various FCM fuel arrangements in accordance with this disclosure;

FIG. 6 is a graph illustrating the correlation between the moderator temperature coefficient and burnup for various FCM fuel arrangements in accordance with this disclosure;

FIG. 7A is a graph illustrating the correlation between the moderator temperature coefficient and burnup for various FCM fuel arrangements in accordance with this disclosure;

FIG. 7B is a graph illustrating the correlation between the moderator temperature coefficient and burnup for various FCM fuel arrangements in accordance with this disclosure;

FIG. 7C is a graph illustrating the correlation between the moderator temperature coefficient and burnup for various FCM fuel arrangements in accordance with this disclosure;

FIG. 7D is a graph illustrating the correlation between the moderator temperature coefficient and burnup for various FCM fuel arrangements in accordance with this disclosure;

FIG. 8 is a graph illustrating the correlation between the moderator temperature coefficient and effective full-power days for various FCM fuel arrangements in accordance with this disclosure;

FIG. 9A is a graph illustrating the correlation between the fuel temperature coefficient and burnup for various FCM fuel arrangements in accordance with this disclosure;

FIG. 9B is a graph illustrating the correlation between the fuel temperature coefficient and burnup for various FCM fuel arrangements in accordance with this disclosure;

FIG. 9C is a graph illustrating the correlation between the fuel temperature coefficient and burnup for various FCM fuel arrangements in accordance with this disclosure;

FIG. 9D is a graph illustrating the correlation between the fuel temperature coefficient and burnup for various FCM fuel arrangements in accordance with this disclosure;

FIG. 10 is a graph illustrating the correlation between the fuel temperature coefficient and effective full-power days for various FCM fuel arrangements in accordance with this disclosure;

FIG. 11 is a graph illustrating the correlation between the k-infinity multiplication factor and burnup for a FCM fuel arrangement with different burnable poisons in accordance with this disclosure;

FIG. 12 is a cross-sectional view of the top plate of a 12×12 FCM replacement fuel assembly for a reference standard 16×16 solid fuel assembly in accordance with this disclosure;

FIG. 13 is a cross-sectional view of a 12×12 FCM replacement fuel assembly for a reference standard 16×16 solid fuel assembly in accordance with this disclosure;

FIG. 14 is a cross-sectional view of the bottom plate of a 12×12 FCM replacement fuel assembly for a reference standard 16×16 solid fuel assembly in accordance with this disclosure;

FIG. 15 is a cross-sectional view of the bottom plate of a 12×12 FCM replacement fuel assembly for a reference standard 16×16 solid fuel assembly in accordance with this disclosure;

FIG. 16 is a cross-sectional view of the top plate of a 13×13 FCM replacement fuel assembly for a reference standard 17×17 solid fuel assembly in accordance with this disclosure;

FIG. 17 is a cross-sectional view of a 13×13 FCM replacement fuel assembly for a reference standard 17×17 solid fuel assembly in accordance with this disclosure;

FIG. 18 is a cross-sectional view of a 13×13 FCM replacement fuel assembly for a reference standard 17×17 solid fuel assembly in accordance with this disclosure;

FIG. 19 is a cross-sectional view of the bottom plate of a 13×13 FCM replacement fuel assembly for a reference standard 17×17 solid fuel assembly in accordance with this disclosure; and

FIG. 20 is a cross-sectional view of the bottom plate of a 13×13 FCM replacement fuel assembly for a reference standard 17×17 solid fuel assembly in accordance with this disclosure.

### DETAILED DESCRIPTION OF THE ILLUSTRATED EMBODIMENT

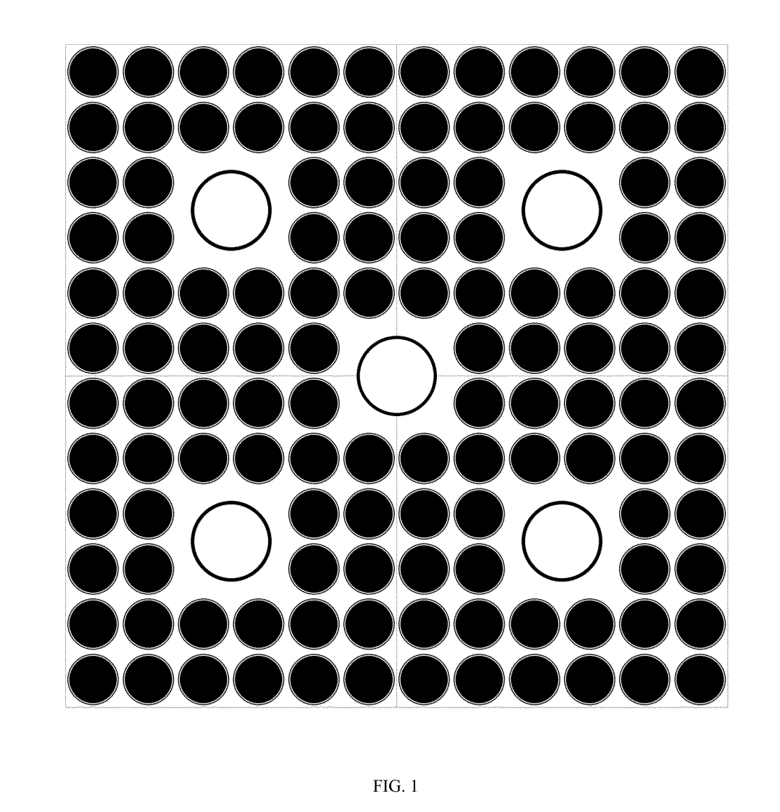

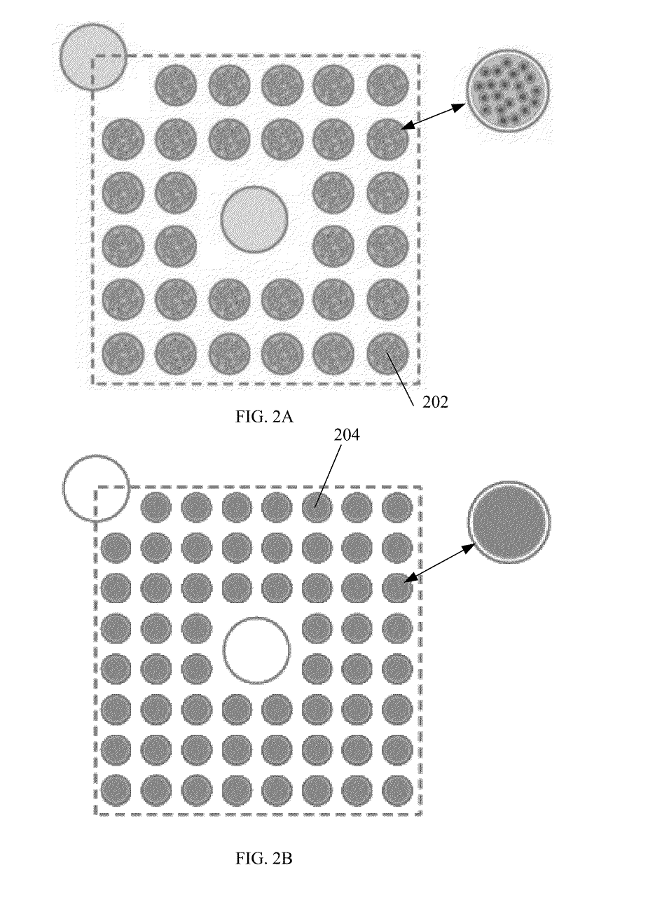

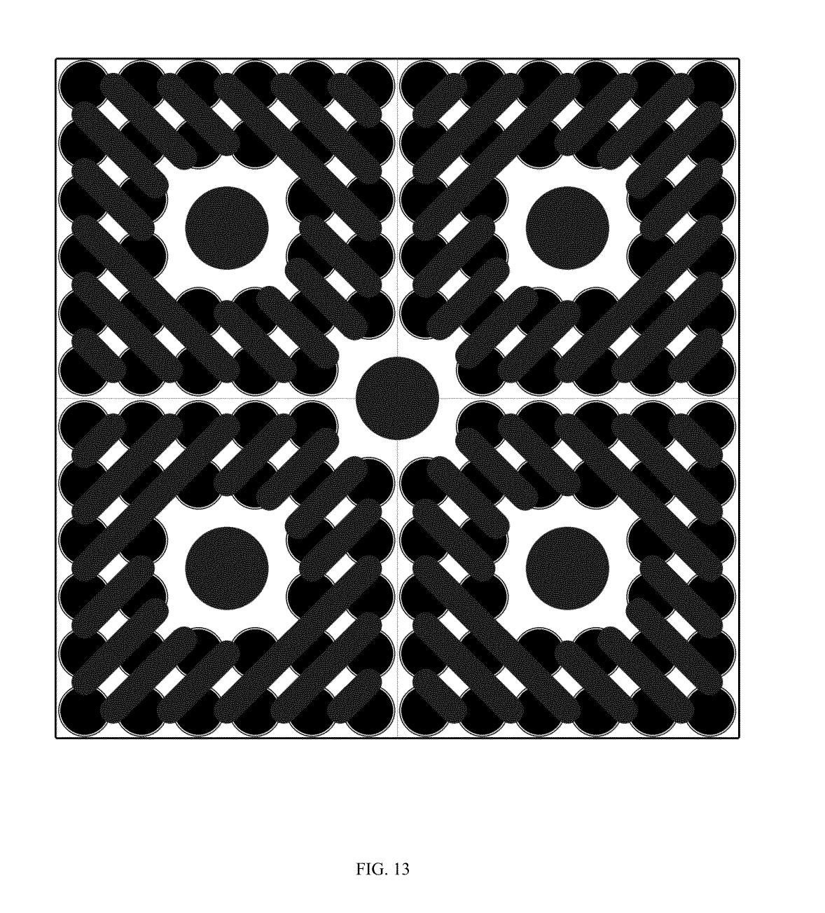

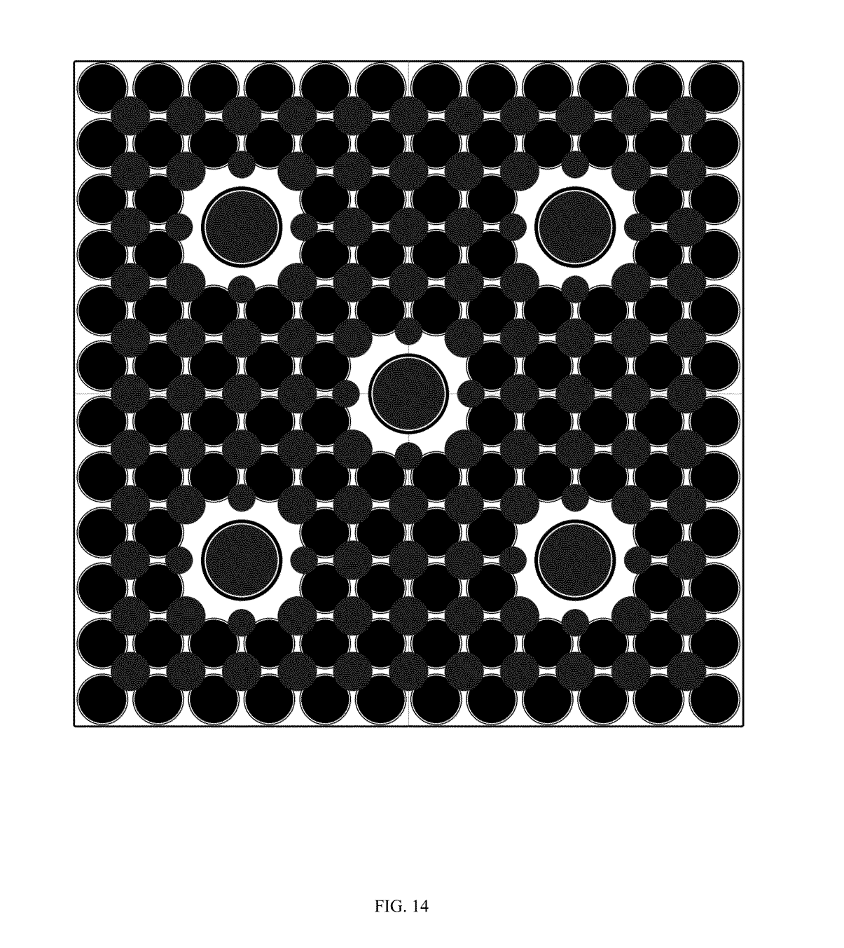

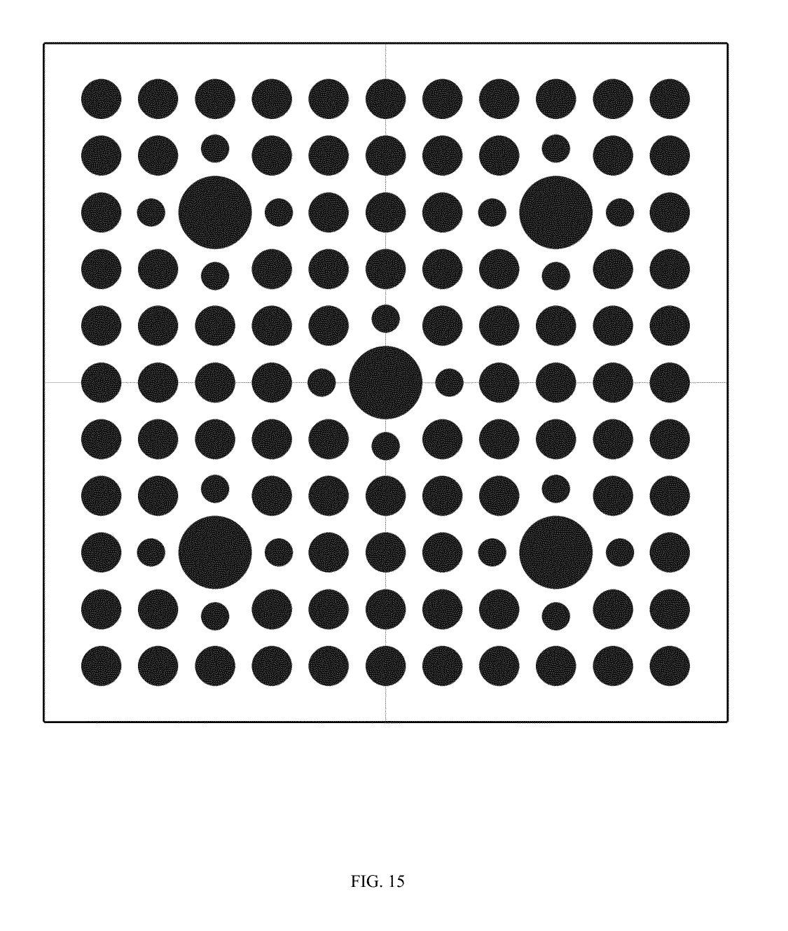

Turning to the Figures and to FIG. 1 in particular, a cross-sectional view of a 12×12 FCM replacement fuel assembly for a reference standard 16×16 solid fuel assembly is shown. 16×16 solid fuel assemblies are deployed in CE SYSTEM-80 reactors, such as SK OPR (Optimized Power Reactor) and APR (Advanced Power Reactor) reactors. A one-fourth cross-sectional view of a reference standard 16×16 solid UO₂ fuel assembly is shown in FIG. 2B. Fuel rods within a fuel assembly are generally arranged in a square matrix. Similarly, a 12×12 replacement fuel assembly comprises twelve (12) rows of fuel pins or rods. Each row generally includes twelve fuel pins while each fuel pin includes one or more fuel pellets. Cross-sectional views of the top and bottom plates of the 12×12 FCM replacement fuel assembly are shown in FIGS. 12 and 15 respectively. FIG. 13 shows a cross-sectional view (upward-looking) of the 12×12 FCM replacement fuel assembly while FIG. 14 shows a cross-sectional view (upward-looking) of the bottom plate of the 12×12 FCM replacement fuel assembly.

To increase the heavy metal mass in a FCM fuel pellet, one approach is to increase the diameter of the FCM fuel pellet. As shown by the one-fourth cross-sectional view of the 12×12 FCM fuel assembly in FIG. 2A, the diameter of a FCM fuel rod 202 in the 12×12 FCM replacement fuel assembly is larger than the diameter of a solid fuel rod 204 in the conventional 16×16 solid fuel assembly. Accordingly, the FCM fuel pellets of the 12×12 FCM fuel assembly have a larger diameter than that of the solid fuel pellets of the reference standard 16×16 FCM fuel assembly; accordingly, the volume in the larger diameter pellets is larger than that in the smaller diameter pellets. This is necessary to allow sufficient fissile material to be accommodated in the TRISO coated particles contained in the FCM fuel pellets.

The possible dimension differences between a 12×12 FCM fuel pellet and a reference standard 16×16 solid fuel pellet is further illustrated in Table 1 below.

| | 16 × 16 | 12 × 12 |
|---|---|---|
| Fuel type | Solid UO₂ | TRISO in SiC matrix |
| Fuel assembly pitch (cm) | 20.58 | 20.58 |
| Pin pitch (cm) | 1.2863 | 1.715 |
| Fuel pin diameter (cm) | 0.950 | 1.664 |
| Pellet diameter (cm) | 0.819 | 1.594 |
| Gap thickness (cm) | 0.0085 | 0.0050 |
| Clad thickness (cm) | 0.0570 | 0.0300 |

In Table 1 above, the two different fuel assemblies have the same fuel assembly pitch while the 12×12 FCM fuel assembly has larger fuel pin and fuel pellet diameters. Accordingly, the volume in the FCM fuel pellet is bigger than that of the reference standard 16×16 solid fuel pellet. The number of rods, disposition and dimensions, including control rod arrangement, are chosen to allow the similar power production in the FCM fuel assembly as in the reference standard fuel assembly and the compatible neutronic and thermohydraulic behavior (including control of reactivity, heat transfer and pressure drop). In one embodiment, the linear power density and volumetric fissile content is maintained in the FCM fuel assembly as in the reference standard fuel assembly by increasing the diameter of the FCM fuel pins and decreasing their number in the fuel assembly, while keeping the same hydraulic diameter and pressure drop as the reference standard fuel assembly.

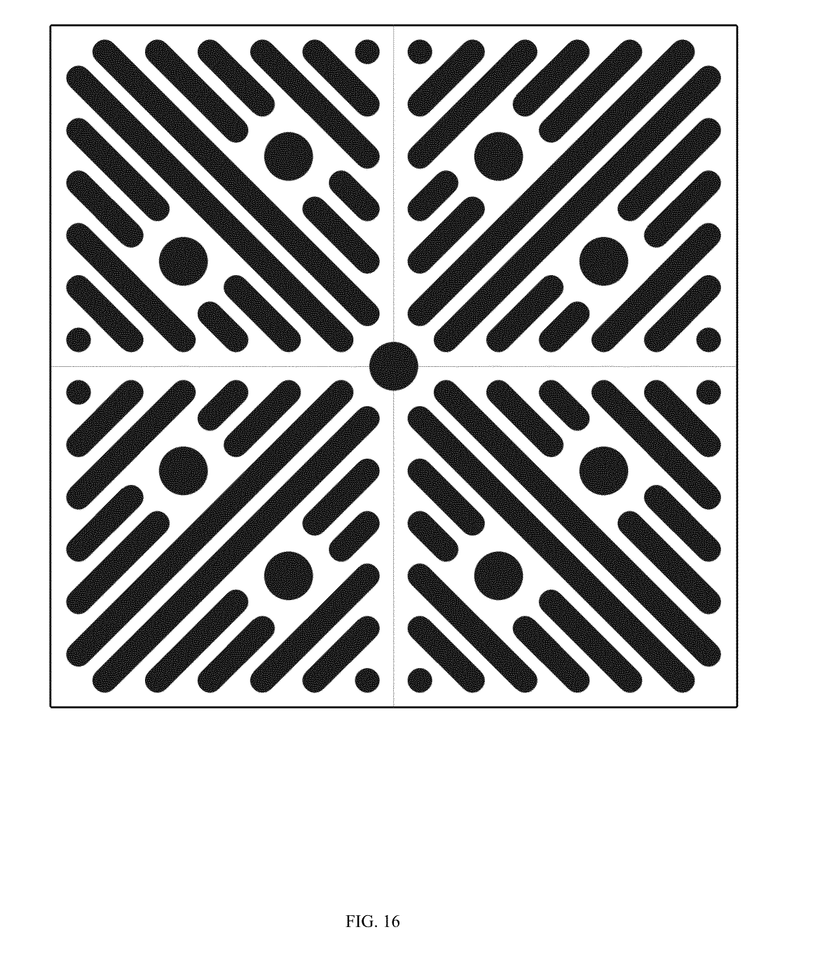

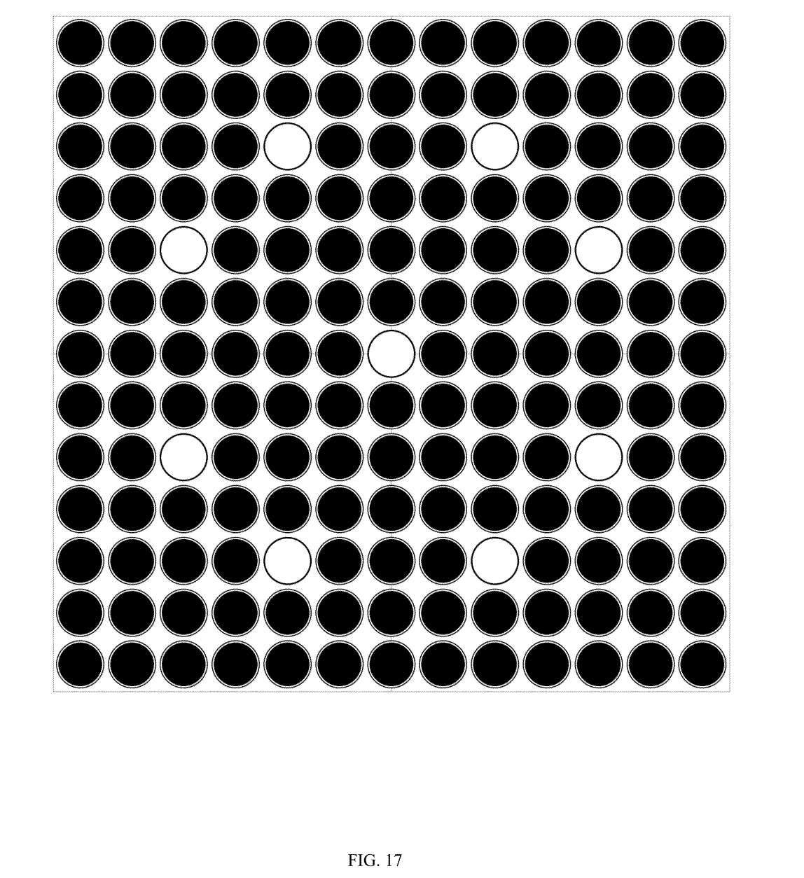

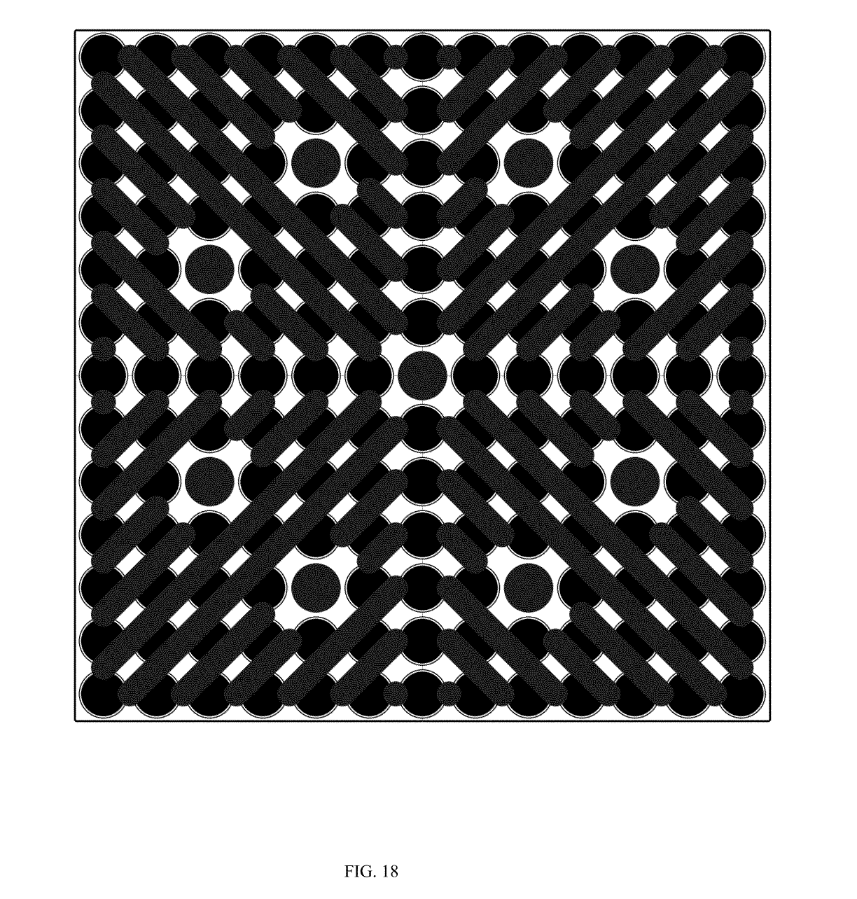

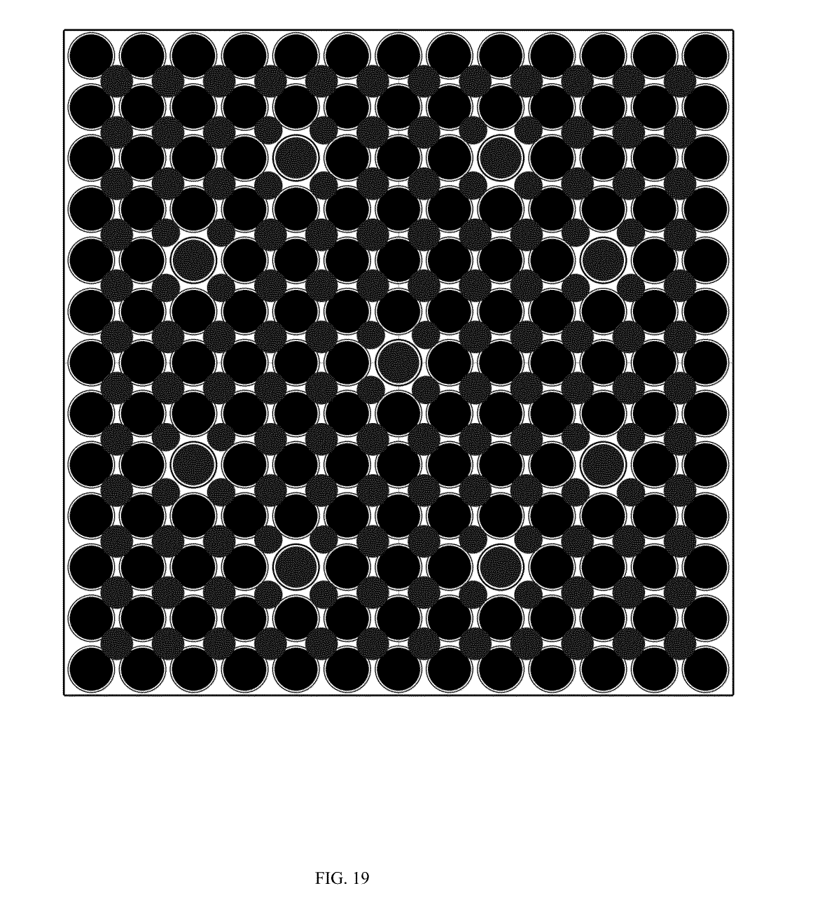

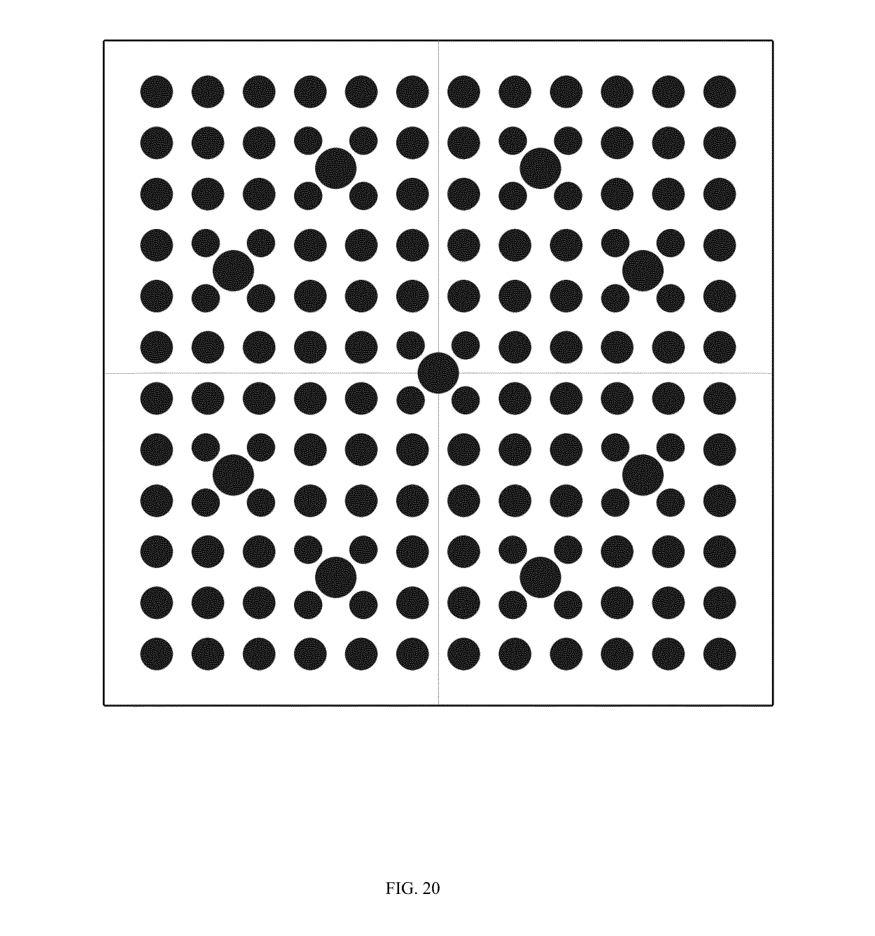

The advantages of the present teachings can also be applied to Westinghouse types of reactors (such as AREVA reactors with 17×17 solid fuel assemblies) and boiling water reactors (“BWRs”). In such cases, 13×13 FCM fuel assemblies are utilized to replace conventional 17×17 solid fuel assemblies. Cross-sectional views of the top and bottom plates of a 13×13 FCM replacement fuel assembly are shown in FIGS. 16 and 20 respectively. FIG. 17 shows a cross-sectional view of the 13×13 FCM replacement fuel assembly while FIG. 18 shows a cross-sectional view (upward-looking) of the 13×13 FCM replacement fuel assembly. Additionally, a cross-sectional view (upward-looking) of the bottom plate of the 13×13 FCM replacement fuel assembly is shown in FIG. 19. The number of rods, disposition and dimensions, including control rod arrangement, are chosen to allow the similar power production in the FCM fuel assembly as in the reference standard fuel assembly and the compatible neutronic and thermohydraulic behavior (including control of reactivity, heat transfer and pressure drop).

In alternate embodiments of the present teachings, the heavy metal mass in a FCM fuel pellet is increased by increasing the kernel diameter of TRISO particles with the pellet. In one embodiment, a TRISO particle comprises a kernel, a buffer layer, an inner pyrolytic carbon (“PyC”) layer, a SiC coating layer, and an outer PyC layer, as more fully set forth in U.S. application Ser. No. 13/567,243, which was previously incorporated by reference. Various cases of increased kernel diameter (“KD”) and heavy metal mass in the FCM fuel pellet are listed in Table 2 below.

| | | Kernel Diameter | | | |
|---|---|---|---|---|---|
| Packing Fraction | | 400 μm | 500 μm | 600 μm | 700 μm |
| PF = 30% | Case name | PF30KD400 | PF30KD500 | PF30KD600 | PF30KD700 |
| | U235 | 25.27% | 19.53% | 16.23% | 14.11% |
| | enrichment | | | | |
| | Heavy metal | 1.64760 | 2.13212 | 2.56485 | 2.94846 |
| | mass(gram) | | | | |
| PF = 40% | Case name | PF40KD400 | PF40KD500 | PF40KD600 | PF40KD700 |
| | U235 | 18.95% | 14.64% | 12.17% | 10.59% |
| | enrichment | | | | |
| | Heavy metal | 2.19689 | 2.84293 | 3.42142 | 3.93217 |
| | mass(gram) | | | | |
| PF = 50% | Case name | PF50KD400 | PF50KD500 | PF50KD600 | PF50KD700 |
| | U235 | 15.16% | 11.72% | 9.74% | 8.47% |
| | enrichment | | | | |
| | Heavy metal | 2.74619 | 3.55372 | 4.27646 | 4.91591 |
| | mass(gram) | | | | |

In Table 2 above, each case name indicates a packing fraction and a TRISO particle kernel diameter. For example, PF40KD500 indicates a packing fraction of 50% and a kernel diameter of 500 μm. As used herein, packing fraction (“PF”) indicates the percentage of the volume of a FCM fuel pellet taken by the TRISO particles. For the cases listed in Table 2, Uranium-235 (“U235”) enrichment of the TRISO particles is equivalent to U235 0.2 gram of conventional solid UO₂ (U235 4w/o). Additionally, as the TRISO particle kernel diameter varies under difference cases, the thickness of each other layer of the TRISO particles remains constant, as shown in Table 3 below.

| TRISO fuel particle layer | Parameter | Value | |
|---|---|---|---|
| Kernel | Diameter | Various | |
| | Uranium Nitride | 14.32 | g/cc |
| | (UN) density | | |
| Buffer layer | Thickness | 50 | μm |
| | Density | 1.05 | g/cc |
| Inner PyC coating layer | Thickness | 35 | μm |
| | Density | 1.9 | g/cc |
| SiC coating layer | Thickness | 35 | μm |
| | Density | 3.18 | g/cc |
| Outer PyC coating layer | Thickness | 20 | μm |
| | Density | 1.9 | g/cc |

Turning back to Table 2, the height of the FCM fuel pellet is assumed to be 1.0 cm. However, FCM fuel pellet diameter, height, and other dimensional parameters are indicative, as larger or smaller dimensions can be employed with lower or higher values of enrichment to result in a similar amount of fissile material in the FCM fuel pellet. For the different cases listed in Table 2, FCM fuel assembly depletion calculation is performed with McCARD and DeCART codes. McCARD (Monte Carlo Code for Advanced Reactor Design and Analysis) is a Monte Carlo neutron-photon transport simulation code. It estimates neutronics design parameters of a nuclear reactor or a fuel system such as effective multiplication factor. For example, McCARD is suited for performing the reactor fuel burnup analysis with a built-in depletion equation solver based on a matrix exponential method. In one implementation, McCARD is written in an objected-oriented programming language, such as C++ or Java. Similarly, DeCART (Deterministic Core Analysis based on Ray Tracing), a three-dimensional whole-core discrete integral transport code, also performs neutronics calculations.

One result of the FCM fuel assembly depletion calculation is a multiplication factor of the fuel assembly. The multiplication factor (“k”) measures the average number of neutrons from one fission that cause another fission. The remaining neutrons either are absorbed in non-fission reactions or leave the nuclear system without being absorbed. When the value of k is smaller than one (1), the nuclear system cannot sustain a chain reaction because the reaction dies out. Where the value of k is one, each fission causes an average of one more fission, and thus leads to a constant fission level. In one implementation, a 12×12 FCM fuel assembly (“FA”) depletion calculation is performed with the assumptions that the fuel temperature is 900K, the coolant temperature is 600K, and the coolant density is 0.7 g/cc. The calculation results are shown in Table 4 below for values of the packing fraction of 30%, 40% and 50% and for values of kernel diameter of 400, 500, 600 and 700 microns. The Table 4 shows the k eff values and the uranium enrichment required to obtain the k eff for the given packing fraction and kernel diameter in the 12×12 FCM fuel assembly.

| | KD = | KD = | KD = | KD = |
|---|---|---|---|---|
| | 400 μm | 500 μm | 600 μm | 700 μm |
| PF = 30% | 25.27% | 19.53% | 16.23% | 14.11% |
| McCARD | 1.59885 | 1.55881 | 1.52684 | 1.50136 |
| DeCART | 1.59710 | 1.55785 | 1.52693 | 1.50189 |
| Diff(pcm) | −68.5 | −39.5 | 3.9 | 23.5 |
| PF = 40% | 18.95% | 14.64% | 12.17% | 10.59% |
| McCARD | 1.55303 | 1.50646 | 1.46954 | 1.44001 |
| DeCART | 1.55295 | 1.50786 | 1.47219 | 1.44333 |
| Diff(pcm) | −3.3 | 61.6 | 122.5 | 159.7 |
| PF = 50% | 15.16% | 11.72% | 9.74% | 8.47% |
| McCARD | 1.51308 | 1.46111 | 1.42048 | 1.38727 |
| DeCART | 1.51496 | 1.4648 | 1.42498 | 1.3927 |
| Diff(pcm) | 82.0 | 172.4 | 222.3 | 281.0 |

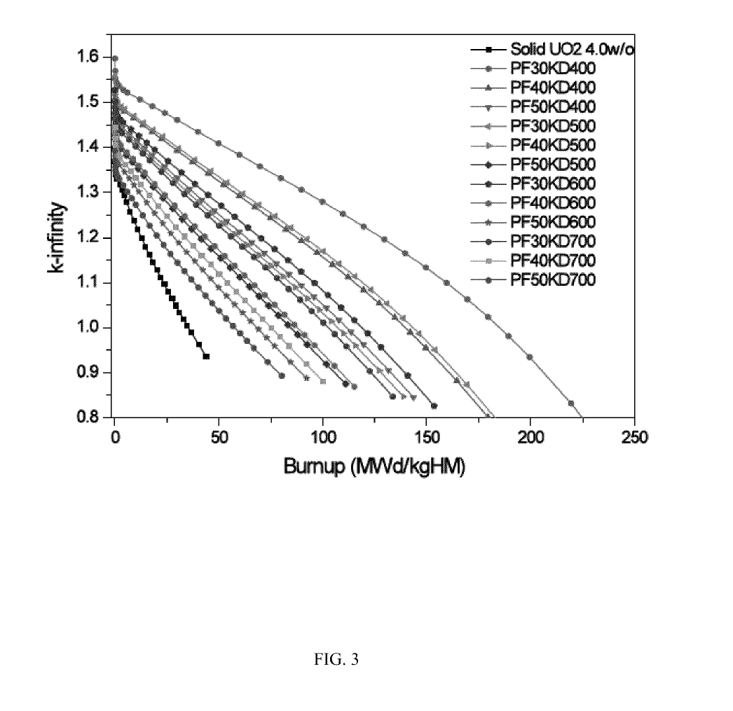

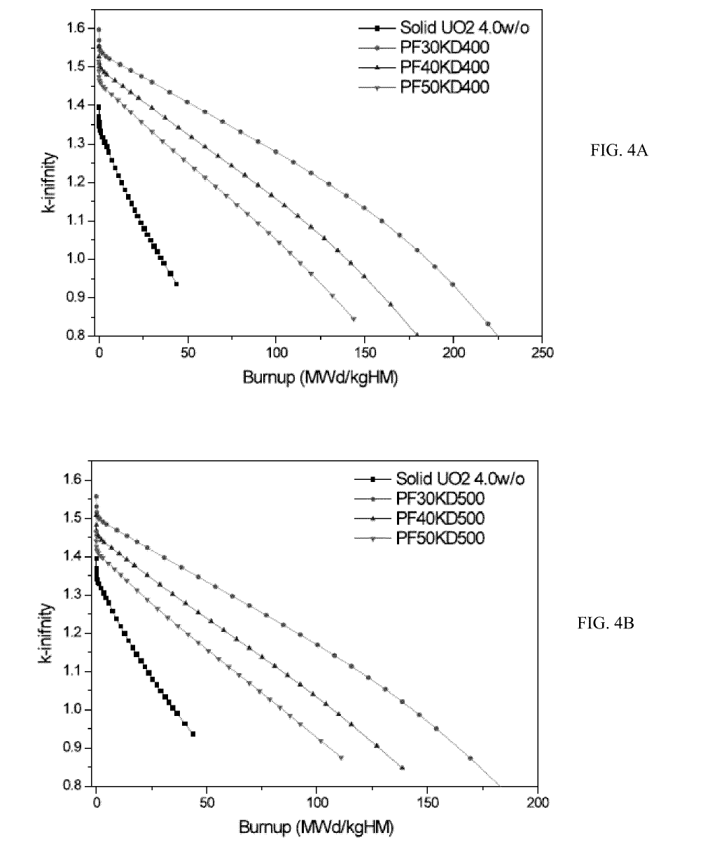

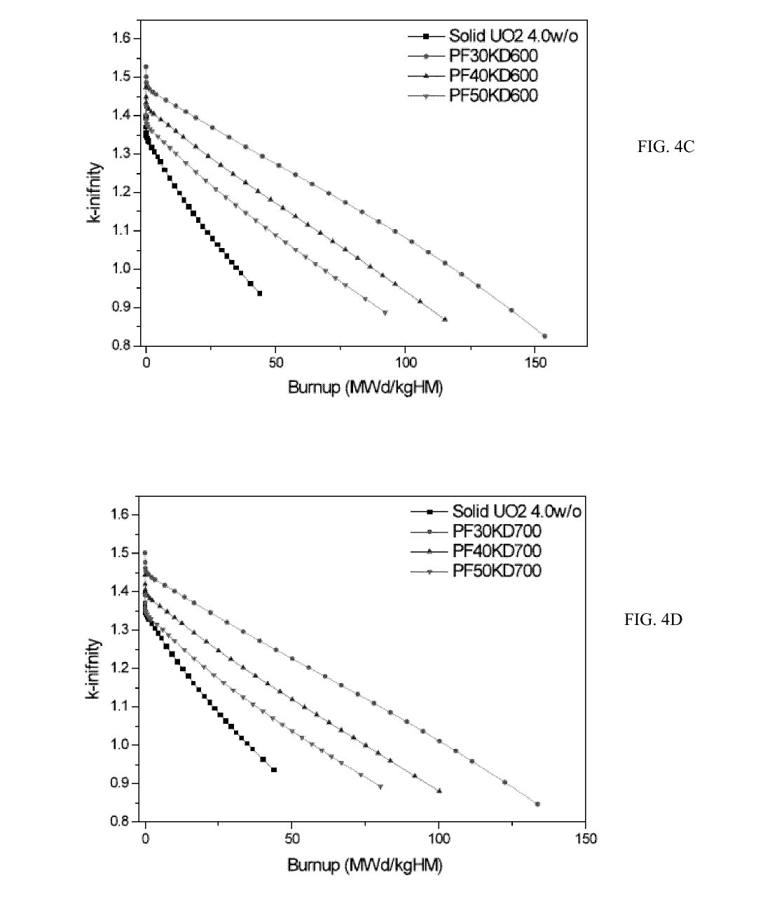

In Table 4, the difference between the calculation results from the McCARD code and the DeCART code is very small for each case. For further analysis, the DeCART code is used to calculate the multiplication factor and other parameters of the illustrative 12×12 FCM fuel assemblies. Calculation results are illustrated by reference to FIG. 3. A correlation between k-infinity and burnup is graphed in FIG. 3 for thirteen cases, including the twelve cases of Table 4 and the conventional 16×16 solid fuel UO₂ assembly. Based on TRISO particle kernel diameter sizes, FIG. 3 is further illustrated as four additional FIGS. 4A, 4B, 4C and 4D. FIGS. 3, 4A, 4B, 4C, 4D demonstrate, at a given level of k-infinity, the burnup of each of the FCM fuels is higher than the burnup of a conventional 16×16 solid fuel assembly.

Furthermore, at a given level of k-infinity and a fixed TRISO particle kernel diameter, the rate of fuel burnup bears an inverse correlation with the packing fraction of the FCM fuel pellet. In other words, a higher packing fraction corresponds to a slower fuel burnup. Accordingly, a higher packing fraction (such as 50%) is more desirable than a lower packing fraction (such as 30%) because a longer time to burnup is desirable. Additionally, at a given level of k-infinity and a fixed packing fraction, the fuel burnup rate bears an inverse correlation with the TRISO particle kernel diameter. Therefore, a larger TRISO particle kernel diameter (such as 700 μm) is more desirable than a smaller TRISO particle kernel diameter (such as 400 μm) because a longer time to compete the fuel burnup is desirable.

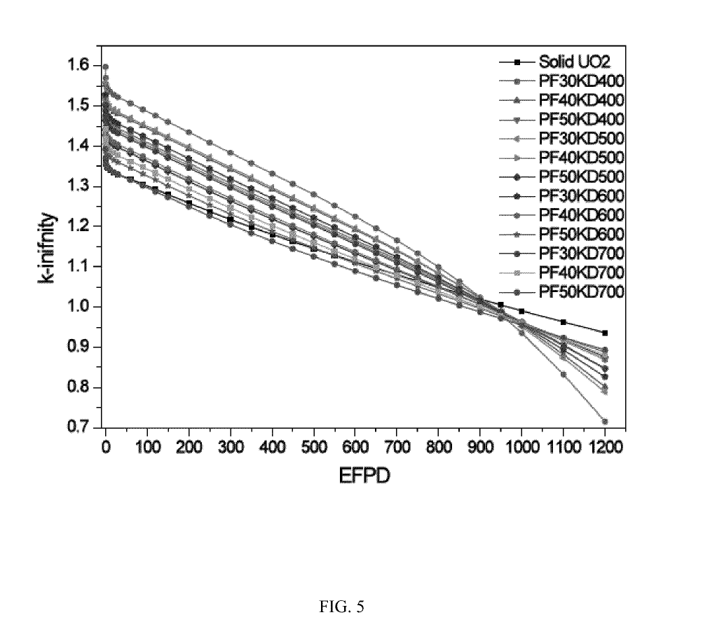

A correlation between the multiplication factor and effective full-power days (EFPD) for each of the thirteen cases is graphed in FIG. 5. EFPD is a measure of a fuel assembly's energy generation, and is determined as a ratio between the heat generation (planned or actual) in megawatt days thermal (MWdt) and licensed thermal power in megawatts thermal (MWt). FIG. 5 shows that, at a given level of k-infinity, the EFPD for FCM fuels with increased TRISO particle kernel diameter is higher than that of solid UO₂ fuel and the EFPD for FCM fuels with smaller TRISO particle diameter is lower than that of solid UO₂ fuel. A high EFPD value for fuel is very desirable in reactor operations.

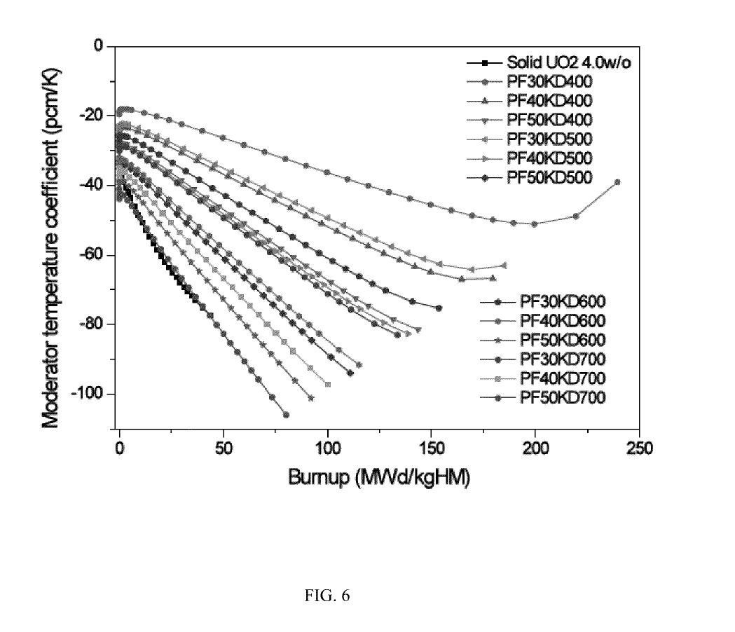

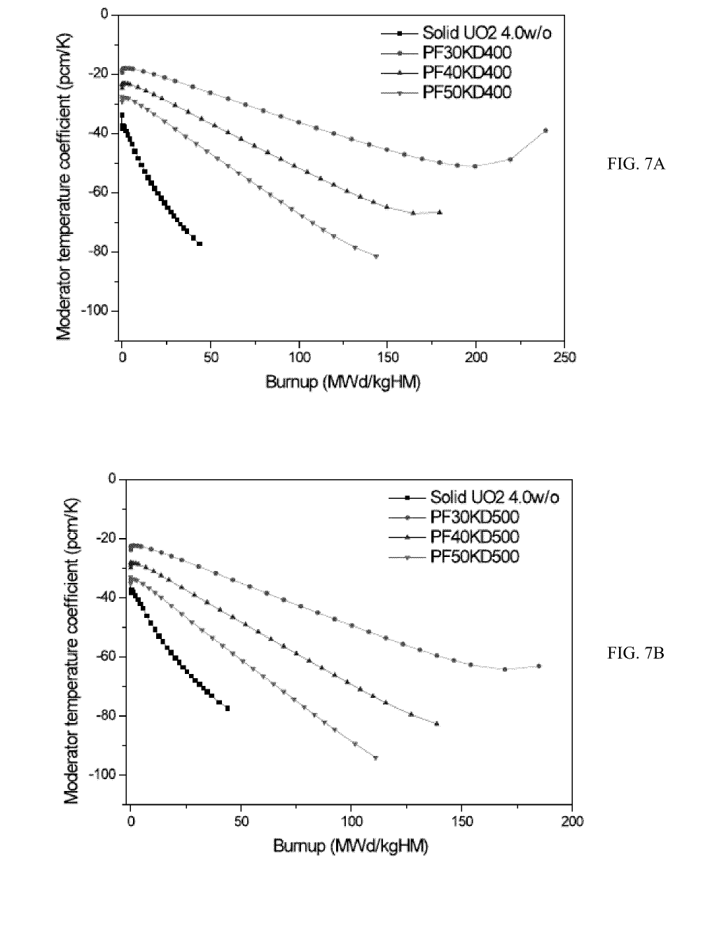

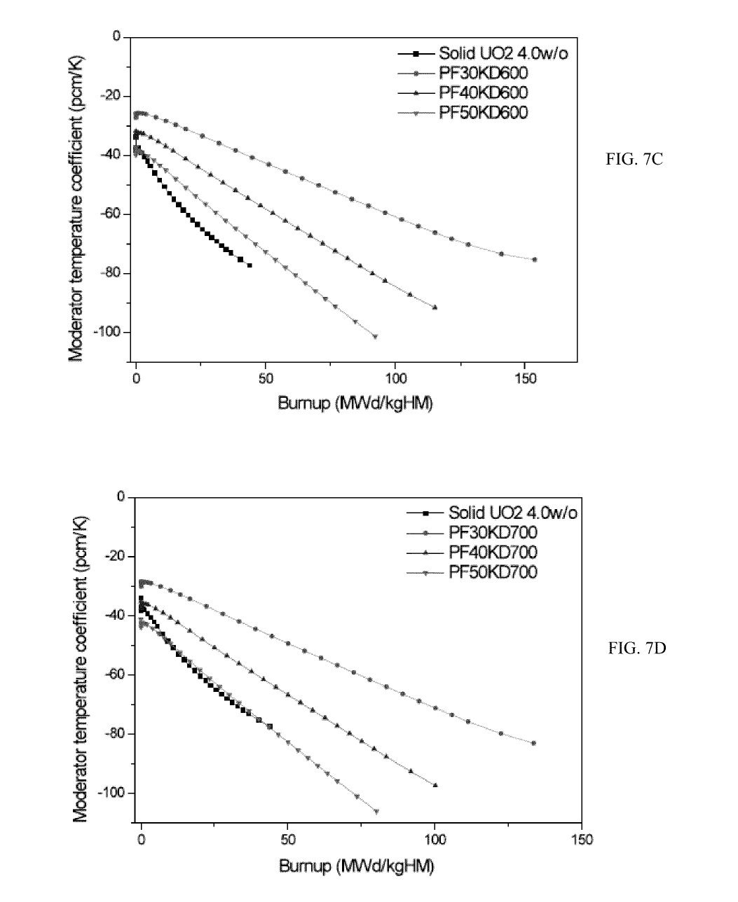

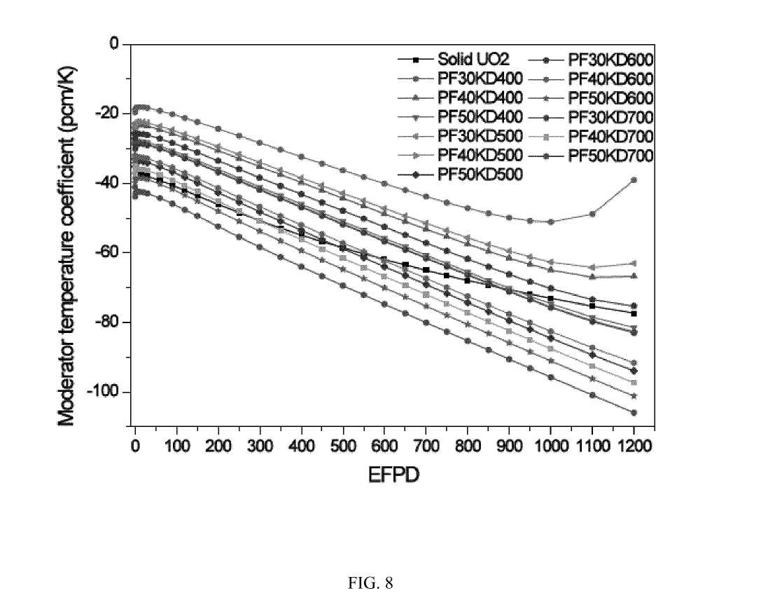

A neutron moderator (such as water) plays a critical role for nuclear reactors. The moderator is a medium that reduces the speed of fast neutrons, and turns them into thermal neutrons capable of sustaining a nuclear chain reaction. As the moderator's temperature increases, it becomes less dense and slows down fewer neutrons, which results in a negative change of reactivity. The change of reactivity per degree change of the moderator temperature is termed as the moderator temperature coefficient (MTC). MTC is an important operational parameter connected with safety considerations. A negative MTC is necessary to reach stability during changes in temperature caused by reactivity. Furthermore, MTC correlates with fuel composition and therefore it will change with fuel burnup. Such correlations are calculated and graphed in FIG. 6 for the thirteen cases. FIG. 6 is further illustrated as four additional FIGS. 7A, 7B, 7C, 7D.

FIGS. 6, 7A, 7B, 7C, 7D show that, at a given level of MTC, each of the FCM fuels with increased TRISO particle kernel diameter achieves a higher burnup than the conventional solid UO₂ fuel. Furthermore, at a given level of MTC and a fixed TRISO particle kernel diameter size, the packing fraction bears an inverse correlation with the fuel burnup rate. Accordingly, a higher packing fraction (such as 50%) is more desirable than a lower packing fraction (such as 30%). Additionally, at a given level of MTC and a fixed packing fraction, the fuel burnup rate bears an inverse correlation with the TRISO particle kernel diameter. Therefore, a larger TRISO particle kernel diameter (such as 700 μm) is more desirable than a smaller TRISO particle kernel diameter (such as 400 μm).

A correlation between the MTC and EFPD for each of the thirteen cases is graphed in FIG. 8. FIG. 8 shows that, at certain level of MTC, the EFPD for FCM fuels with increased TRISO particle kernel diameter can be higher than that of solid UO₂ fuel. For example, with a packing fraction of 30% and a TRISO particle kernel diameter of 600 μm, the EFPD for FCM fuel is higher than that of solid UO₂ fuel. A high EFPD value for fuel is very desirable in reactor operations.

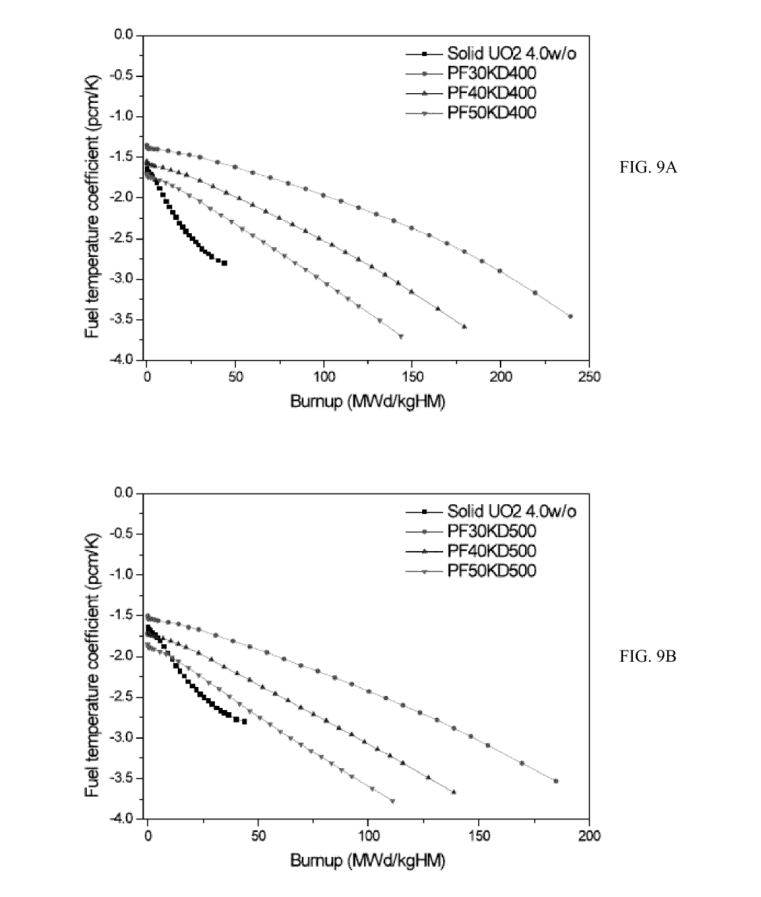

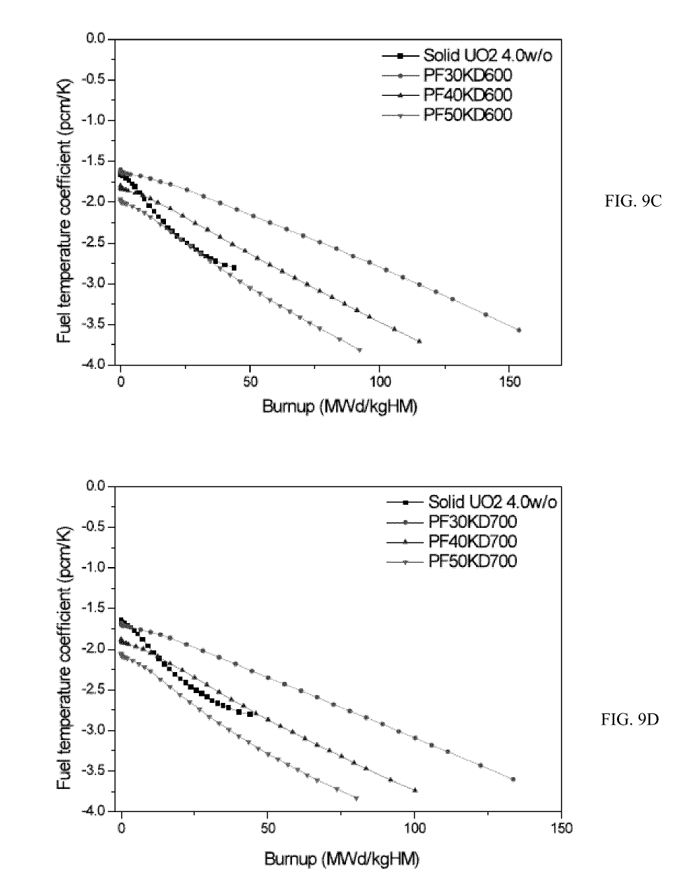

Fuel temperature coefficient (FTC) is another temperature coefficient of reactivity. FTC is the change in reactivity per degree change in fuel temperature. FTC quantifies the amount of neutrons that the nuclear fuel absorbs from the fission process as the fuel temperature increases. A negative FTC is generally considered to be even more important than a negative MTC because fuel temperature immediately increases following an increase in reactor power. Moreover, FTC correlates with fuel burnup. Such correlation is calculated and graphed in FIGS. 9A, 9B, 9C, 9D for the thirteen cases.

FIGS. 9A, 9B, 9C, 9D demonstrate that, at a given level of FTC, the FCM fuels with increased TRISO particle kernel diameters generally achieve a higher burnup than the conventional solid UO₂ fuel. Where the kernel diameter is 700 μm, the fuel burnup is similar to that of the conventional solid UO₂ fuel. Therefore, the size 700 μm and larger is a desirable choice for TRISO particle kernel diameter for FCM fuel replacement of standard solid oxide LWR fuel, because it provides a slower burnup rate that can match the burnup rate of reference standard LWR fuel. These figures further illustrate that the packing fraction bears an inverse correlation with the fuel rate of burnup. Accordingly, a higher packing fraction (such as 40 or 50%) is more desirable than a lower packing fraction (such as 30%) because it provides a slower burning fuel load.

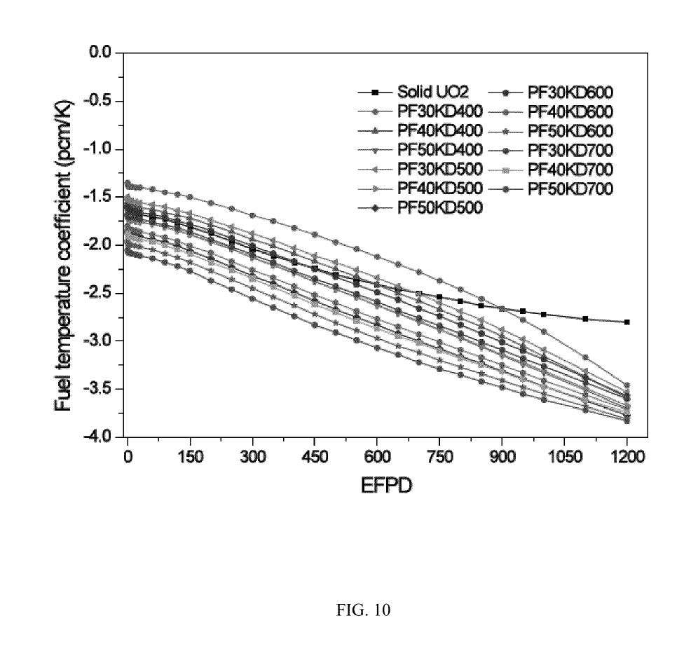

A correlation between the FTC and EFPD for each of the thirteen cases is graphed in FIG. 10. FIG. 10 shows that, at certain level of FTC, FCM fuel with increased packing fraction and TRISO particle kernel diameter can achieve comparable EFPD as that of solid UO₂ fuel.

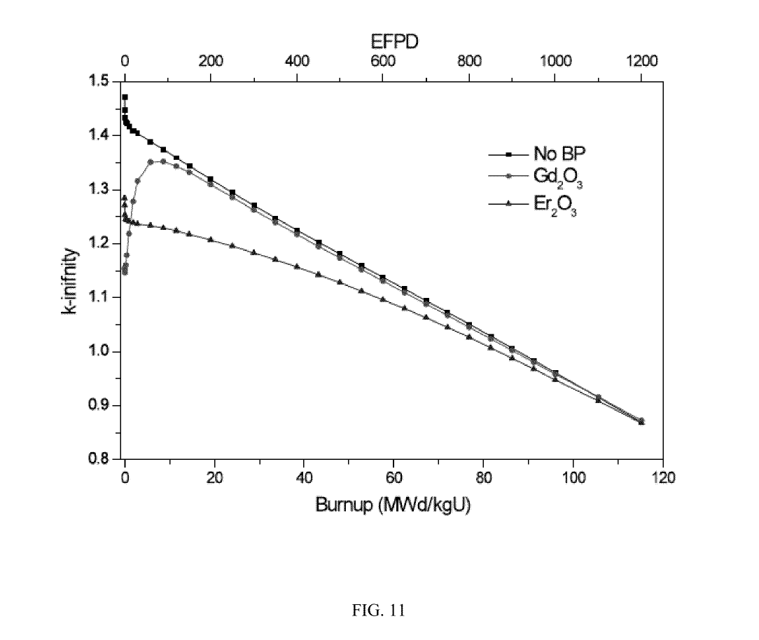

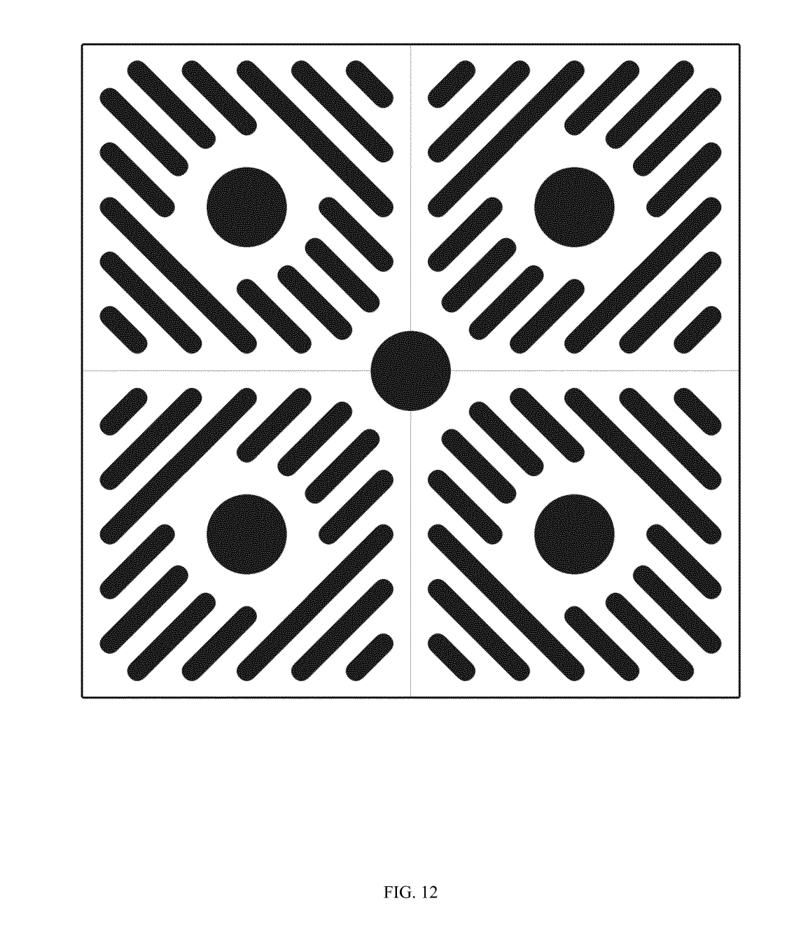

In nuclear engineering, nuclear fuel exhibits high reactivity when initially loaded, particularly the higher enrichment FCM fuel, as higher enrichment is required by the use of TRISO particles in the inert SiC matrix, with respect to the reference standard solid oxide fuel. A neutron poison, which is a substance with a large neutron absorption cross section, is sometimes inserted into a reactor core to lower such high reactivity. Burnable poisons are special types of neutron poisons that are converted into materials of relatively low absorption cross section. Ideally, burnable poisons decrease their negative reactivity at the same rate at which the FCM fuel's excessive positive reactivity is depleted. An analysis of the correlation between k-infinity and fuel burnup for a 12×12 FCM fuel with burnable poisons, for example, Gd₂O₃ and Er₂O₃, is shown in FIG. 11. In this analysis, the burnable poison is a contained as a sintered mixture in the SiC matrix. Additionally, the 12×12 FCM fuel has a packing fraction of 40% and a TRISO particle kernel diameter of 600 μm. FIG. 11 shows that the Gd₂O₃ burnable poison is more rapidly burned out than the Er₂O₃ burnable poison. Accordingly, the Er₂O₃ burnable poison is a more desirable burnable poison for the FCM fuel.

Obviously, many additional modifications and variations of the present disclosure are possible in light of the above teachings. Thus, it is to be understood that, within the scope of the appended claims, the disclosure may be practiced otherwise than is specifically described above.

The foregoing description of the disclosure has been presented for purposes of illustration and description, and is not intended to be exhaustive or to limit the disclosure to the precise form disclosed. The description was selected to best explain the principles of the present teachings and practical application of these principles to enable others skilled in the art to best utilize the disclosure in various embodiments and various modifications as are suited to the particular use contemplated. It is intended that the scope of the disclosure not be limited by the specification, but be defined by the claims set forth below.

What is claimed is:

1. A fully ceramic micro-encapsulated (FCM) fuel assembly for a nuclear reactor comprising:
i) a set of FCM fuel rods bundled in a first square matrix arrangement wherein each FCM fuel rod in the set of FCM fuel rods includes a set of FCM fuel pellets wherein the FCM fuel assembly corresponds to a solid oxide fuel assembly comprising a set of solid oxide fuel rods bundled in a second square matrix arrangement wherein each solid oxide fuel rod in the set of solid oxide fuel rods includes a set of solid oxide fuel pellets wherein a diameter of each FCM fuel pellet in the set of FCM fuel pellets is larger than a diameter of each solid oxide fuel pellet in the set of solid oxide fuel pellets and the horizontal dimension of the first square matrix is smaller than the horizontal dimension of the second square matrix.

2. The FCM fuel assembly of claim 1 wherein each dimension of the first square matrix is a number of fuel rods and each dimension of the second square matrix is a number of fuel rods.

3. The FCM fuel assembly of claim 2 wherein the horizontal dimension of the first square matrix is twelve and the horizontal dimension of the second square matrix is sixteen.

4. The FCM fuel assembly of claim 2 wherein the horizontal dimension of the first square matrix is thirteen and the horizontal dimension of the second square matrix is seventeen.

5. The FCM fuel assembly of claim 1 wherein the nuclear reactor is a light water reactor.

6. The FCM fuel assembly of claim 1 wherein each FCM fuel pellet in the set of FCM fuel pellets includes a plurality of tristructural-isotropic (TRISO) particles wherein a diameter of the kernel of each TRISO particle of the plurality of TRISO particles is larger than three hundred ninety nine micrometers.

7. The FCM fuel assembly of claim 6 wherein each FCM pellet in the set of FCM pellets has a packing fraction larger than twenty nine percent.

8. A fully ceramic micro-encapsulated (FCM) fuel pellet in a FCM fuel assembly for a nuclear reactor comprising:
i) a plurality of tristructural-isotropic (TRISO) particles wherein a diameter of the kernel of each TRISO particle of the plurality of TRISO particles is larger than three hundred ninety nine micrometers.

9. The FCM fuel pellet of claim 8 wherein the FCM pellet has a packing fraction larger than twenty nine percent.

10. The FCM fuel pellet of claim 8 wherein the nuclear reactor is a light water reactor.

11. The FCM fuel pellet of claim 8 wherein the FCM fuel pellet is comprised of burnable poison material dispersed in a sintered matrix as oxide.

12. The FCM fuel pellet of claim 11 wherein the burnable poison material is Er₂O₃.
